(19) United States
(12) Patent Application Publication
(10) Pub. No.: US 2005/0146557 A1
(43) Pub. Date: Jul. 7, 2005

(54) Printing apparatus, printing method, and print head

(75) Inventors: Akito Sato, Nagano-ken (JP); Hirokazu Nunokawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/817,438

(22) Filed: Apr. 5, 2004

(30) Foreign Application Priority Data
Apr. 4, 2003 (JP) 2003-101853
Apr. 1, 2004 (JP) 2004-108824

(51) Int. Cl. B41J 2/145; B41J 2/15

(52) U.S. Cl. 347/40

(57) ABSTRACT

An object is to achieve printing of clear ink with a simple configuration and without increasing the printing time. A printing apparatus, a printing method, and a print head for discharging droplets of ink having color material to a medium at a predetermined resolution, and discharging droplets of ink not having color material to the medium at a resolution that is different from the predetermined resolution are achieved.

### CROSS-REFERENCE TO RELATED APPLICATIONS

The present application claims priority upon Japanese Patent Application No. 2003-101853 filed on Apr. 4, 2003 and Japanese Patent Application No. 2004-108824 filed on Apr. 1, 2004, which are herein incorporated by reference.

### BACKGROUND OF THE INVENTION

1. Field of the Invention

The present invention relates to printing apparatuses, printing methods, and print heads.

2. Description of the Related Art

Inkjet printers are one type of devices for outputting images processed by computer or images captured by digital camera. Inkjet printers print images by ejecting ink to form dots on a print medium.

Inkjet printers use ink that is created by dissolving dye or pigment in a solvent, but in recent years printing properties have been improved using ink (herein, referred to as “clear ink”) that has specific functions and does not include color material such as dye or pigment. More specifically, the clear ink is used with the following objectives in mind:
(1) Correcting unevenness in luster;
(2) Correcting ink bleeding; and
(3) Improving the printing speed.

First, the item (1) “correcting unevenness in luster” is described.

Generally pigment-based ink has a high degree of luster (the proportion of an incoming light at a fixed angle that is reflected at the same diagonal), and thus differences in the degree of luster occur if areas of high and low dot density are mixed in the same printed image, and these cause unevenness in luster and provide an unnatural feeling to the image. FIG. 16A is a diagram that schematically shows a cross section of a dot formed by a dye-based ink. Further, FIG. 16B is a diagram that schematically shows a cross section of dots formed by a pigment-based ink.

As shown in FIG. 16A, dye-based ink 301 favorably permeates into a print medium (for example, a print paper) 300. In contrast, as shown in FIG. 16B, pigment-based ink 302 and 303 do not easily permeate into the print medium 300, and thus at sections where the color is very dark (that is, portions to which an extremely large amount of pigment ink is adhered), an island of pigment ink 303 is formed on and thickly cover the surface of the print medium 300, completely obscuring the texture of the surface of the print medium 300.

The light reflectance is generally low at surface portions 300a and 302a, which are areas of very bright color where the texture of the surface of the print medium 300 is favorably exposed, whereas the light reflectance is relatively high at a surface 303a of an island of the pigment ink 303, which is an area of extremely dark color, due to the properties of the ink. Thus, when the surface portions 300a and 302a, which have low light reflectance, and the surface 303a, which has high light reflectance, are adjacent to one another, then the surface 303a of a dark portion whose light reflectance is high may noticeably appear shiny.

Also, a surface 303b of the edge portion of the island of pigment ink 303 (that is, a portion where there is a sudden change in brightness) is slanted and thus depending on the viewing angle or the angle of incidence of the light, only that portion may noticeably appear shiny. This difference in light reflectance of the printed object surface, that is, the difference in the degree of luster is assumed to be a cause of the unevenness in luster in printed objects using pigment ink.

Accordingly, unevenness in luster has been reduced by introducing ink (clear ink) that has a degree of luster equivalent to that of pigment-based ink and does not include color material, to areas where the density of dots formed by ink including color material (hereinafter, referred to as “color ink”) is low.

Item (2) “correcting ink bleeding” is described next.

In recent years, to produce high quality images, the grainy feel in images has been reduced by reducing the size of the droplets of the ejection ink so as to achieve smaller dot size, and the number of expressible gradations has been increased without increasing the matrix size of a single pixel. However, if the ink bleeds on the print medium, there are instances where the formed dots cannot be made sufficiently small in spite of the reduced size of the ink droplets, and the bleeding of the ink may result in poor image quality.

Accordingly, to prevent such problems, clear ink that is created by dissolving a substance in a solvent to prevent the bleeding of ink by causing a chemical change between the clear ink and the color ink is discharged to or near sections where dots of the color ink are formed, thereby preventing the bleeding.

Also, in recent years, print media provided with a coloring layer on their surface have been used to achieve high-quality printing with a less grainy feel to the dots. Print media provided with a coloring layer can be broadly divided into two types, namely absorption type and swelling type media. The absorption type media refer to media in which color is generated by color material contained in the ink adhering to pigment such as silica or alumina included in the coloring layer. The swelling type media refer to media in which color is generated by a polymer such as gelatin included in the coloring layer becoming swollen due to absorption of the ink and trapping the ink within. Most of the silica or the like that is used in the absorption type media chemically bonds with the color material easily, whereas most of the polymer such as gelatin does not chemically react easily with the color material, and thus the swelling type media are characterized by excellent light-resistance since chemical changes do not occur when the polymer is struck by light.

Although print media provided with a coloring layer demonstrate improved quality for natural images in which dots are formed relatively densely, in images where the dot recording rate is low such as for ruled lines, they suffer a problem similar to the bleeding. In the case of swelling type media, if a new ink droplet is discharged before a dot has completely dried, then this results in the formation of a single large dot because the media are in a swellable state so that the dot and the ink droplet can be mixed. In contrast, ink droplets cannot be absorbed further by areas where dots have completely dried and set, and thus subsequently discharged ink droplets form dots at areas that are peripheral to the dots that have been formed and where ink can be absorbed. Thus, ruled lines or the like appears jagged. A similar problem occurs not only when ink is discharged overlapping dots but also when ink is discharged near dots.

Accordingly, to avoid such problems, clear ink made of solvent only is discharged at or near the areas where dots are formed in order to keep the dots from drying and reduce the occurrence of the bleeding such as that described above.

Lastly, item (3) “improving the printing speed” is described below.

As discussed previously, although the image quality is improved when the size of the droplets of ejection ink is reduced in order to achieve the high image quality, when performing “solid printing” in which it is necessary to print an entire surface with the same color, it is necessary to print the entire surface of the print medium using ink droplets each consisting of a small amount of ink, which therefore requires repeated execution of the printing operation, and this results in a drop in the printing speed.

Accordingly, diffusion of the ink is induced to make the size of the dots that are being formed become larger than normal by ejecting clear ink (ink made of only solvent and does not include color material) adjacent to dots formed by the color ink and thereby increasing the print speed.

To print with the clear ink, however, nozzles dedicated for the clear ink must be provided in the print head. Moreover, in the case of conventionally used print heads, which, for example, have nozzle rows constituted by a plurality of nozzles arranged in a row in the sub-scanning direction for each color, a nozzle row made of the same number of nozzles as the nozzle rows for the color ink is also provided for the clear ink.

Then, when printing, the clear ink is discharged to the print medium at the same recording rate (the number of discharges per unit area) as the color ink.

With such a printing method, however, since it is necessary to create bitmap data for the clear ink at the same resolution as that for the color ink and to transfer this data to the printer, the process of creating the bitmap data becomes an overhead that causes delay in processing, and time is also required for transferring the bitmap data, thereby causing the problem of the printing time being lengthened.

Also, the structure of the device is complicated because it is necessary to provide the same number of nozzles for the clear ink as for the color ink, and this is a problem because it raises manufacturing costs.

### SUMMARY OF THE INVENTION

The present invention was arrived at based on the foregoing matters, and it is an object thereof to provide a printing apparatus, a printing method, and a print head that enable printing of the clear ink with a simple configuration and without increasing the printing time.

A primary aspect of the present invention is a printing apparatus such as the following.

A printing apparatus comprises:
a print head having a plurality of nozzles for ejecting ink to form dots, wherein the print head has a first nozzle row for ejecting ink having color material and a second nozzle row for ejecting ink not having color material;
wherein a number per unit area of droplets of the ink not having color material, which are discharged by the second nozzle row, is less than a number per unit area of droplets of the ink having color material, which are discharged by the first nozzle row.

Another primary aspect of the present invention is a printing method such as the following.

A printing method, which employs a print head having a plurality of nozzles for ejecting ink to form dots, the print head having a first nozzle row for ejecting ink having color material and a second nozzle row for ejecting ink not having color material, comprises:
a step of discharging droplets of the ink having color material using the first nozzle row; and
a step of discharging droplets of the ink not having color material using the second nozzle row;
wherein a number per unit area of the droplets of the ink not having color material, which are discharged by the second nozzle row, is less than a number per unit area of the droplets of the ink having color material, which are discharged by the first nozzle row.

A further primary aspect of the present invention is a print head such as the following.

A print head having a plurality of nozzles for ejecting ink to form dots, comprises:
a first nozzle row for ejecting ink having color material; and
a second nozzle row for ejecting ink not having color material;
wherein a number of nozzles making up the second nozzle row is less than a number of nozzles making up the first nozzle row.

A yet further primary aspect of the present invention is a printing method such as the following.

A printing method for performing printing on a medium, comprises:
a step of discharging droplets of ink having color material to a medium at a predetermined resolution; and
a step of discharging droplets of ink not having color material to the medium at a resolution that is different from the predetermined resolution.

Another primary aspect of the present invention is a printing apparatus such as the following.

A printing apparatus comprises
a printhead for ejecting ink to form dots, wherein the print head includes:
a first nozzle row for discharging droplets of ink having color material to a medium at a predetermined resolution; and
a second nozzle row for discharging droplets of ink not having color material to the medium at a resolution that is different from the predetermined resolution.

Other features of the present invention will become apparent through the accompanying drawings and the following description.

### BRIEF DESCRIPTION OF THE DRAWINGS

In order to facilitate a more complete understanding of the present invention and the advantages thereof, reference is now made to the following description taken in conjunction with the accompanying drawings.

FIG. 1 is a diagram schematically showing the structure of a printer and a computer system for printing according to a present embodiment.

FIG. 2 is a block diagram showing the structure of the primary components of the printer focusing on a control circuit in the computer system for printing shown in FIG. 1.

FIG. 3 is a block diagram showing the detailed structure of a computer in the computer system for printing shown in FIG. 1.

FIG. 4 is a diagram showing the detailed structure of a print head used in the printer shown in FIG. 1.

FIG. 5 is a diagram showing functions of driver software included in the computer shown in FIG. 1.

FIG. 6 is a diagram showing a relationship between an amount of discharged color ink per unit area and an amount of ejected clear ink of the printer shown in FIG. 1.

FIG. 7 is a diagram for describing an example of a printing method employing the print head shown in FIG. 4.

FIG. 8A is a diagram showing how nozzles are arranged in the print head according to a first embodiment.

FIG. 8B is a diagram showing how the color ink is ejected according to the first embodiment.

FIG. 8C is a diagram showing how the clear ink is ejected according to the first embodiment.

FIG. 8D is a diagram showing how dots are formed by the color ink according to the first embodiment.

FIG. 8E is a diagram showing how dots are formed by the clear ink according to the first embodiment.

FIG. 9 is a schematic view of a cross section of a dot formed on the print paper by the printer shown in FIG. 1.

FIG. 10 is a diagram showing another example of a structure of the print head of the printer shown in FIG. 1.

FIG. 11 is a diagram for describing an example of a printing operation employing the print head shown in FIG. 10.

FIG. 12A is a diagram showing how the color ink is ejected according to a second embodiment.

FIG. 12B is a diagram showing how the clear ink is ejected according to the second embodiment.

FIG. 12C is a diagram showing how dots are formed by the color ink according to the second embodiment.

FIG. 12D is a diagram showing how dots are formed by the clear ink according to the second embodiment.

FIG. 13 is a diagram for describing an example of a printing operation employing the print head shown in FIG. 10.

FIG. 14A is a diagram showing how the color ink is ejected according to a third embodiment.

FIG. 14B is a diagram showing how the clear ink is ejected according to the third embodiment.

FIG. 14C is a diagram showing how dots are formed by the color ink according to the third embodiment.

FIG. 14D is a diagram showing how dots are formed by the clear ink according to the third embodiment.

FIG. 15A is a diagram showing a modified embodiment of the print head shown in FIG. 4.

FIG. 15B is a diagram showing a modified embodiment of the print head shown in FIG. 10.

FIG. 16A is a cross sectional view of a dot formed by dye-based ink.

FIG. 16B is a cross sectional view of dots formed by pigment-based ink.

### DETAILED DESCRIPTION OF THE INVENTION

At least the following matters will be apparent by the present specification and the accompanying drawings.

A printing apparatus comprises:
a print head having a plurality of nozzles for ejecting ink to form dots, wherein the print head has a first nozzle row for ejecting ink having color material and a second nozzle row for ejecting ink not having color material;
wherein a number per unit area of droplets of the ink not having color material, which are discharged by the second nozzle row, is less than a number per unit area of droplets of the ink having color material, which are discharged by the first nozzle row.

Thus, printing with the clear ink can be achieved using a simple configuration and without increasing the printing time.

In another invention, in addition to the above-mentioned invention, a number of the droplets of the ink not having color material, which are discharged by the second nozzle row, per unit length in a main scanning direction is less than a number of the droplets of the ink having color material, which are discharged by the first nozzle row, per unit length in the main scanning direction. Thus, by reducing the number of ink droplets not having color material that are discharged in the main scanning direction, it is possible to increase the printing speed.

In another invention, in addition to the above-mentioned invention, a number of the droplets of the ink not having color material, which are discharged by the second nozzle row, per unit length in a sub-scanning direction is less than a number of the droplets of the ink having color material, which are discharged by the first nozzle row, per unit length in the sub-scanning direction. Thus, by reducing the number of ink droplets not having color material that are discharged in the sub-scanning direction, it is possible to increase the printing speed.

In another invention, in addition to the above-mentioned invention, a number of nozzles making up the second nozzle row is less than a number of nozzles making up the first nozzle row. Thus, by simplifying the structure of the print head, it is possible to reduce the manufacturing costs.

In another invention, in addition to the above-mentioned invention, the nozzles making up the first and the second nozzle rows are arranged with a predetermined spacing between adjacent nozzles; and scanning is carried out by partially overlapping scanning paths of the print head such that a gap created due to the spacing is filled in. Thus, it is possible to print with ink having color material and ink not having color material without causing banding.

In another invention, in addition to the above-mentioned invention, the ink having color material is a pigment-based ink; and the ink not having color material includes a component for increasing a degree of luster. Thus, it is possible to prevent the occurrence of unevenness in luster without reducing the printing speed.

In another invention, in addition to the above-mentioned invention, dots of the ink not having color material are formed at an area where a density of dots of the ink having color material is low in accordance with that density. Thus, it is possible to adequately correct unevenness in luster and to reduce the consumption of ink not having color material.

In another invention, in addition to the above-mentioned invention, the ink not having color material includes a component for preventing bleeding of the ink having color material; and dots of the ink not having color material are formed at an area where a density of dots of the ink having color material is high in accordance with that density. Thus, bleeding of ink can be reliably prevented without lowering the printing speed.

In another invention, in addition to the above-mentioned invention, a nozzle group making up the first nozzle row and a nozzle group making up the second nozzle row are arranged such that they are misaligned in a sub-scanning direction by a fixed distance. Thus, ink not having color material can be discharged to positions suitable for its relationship with the ink having color material.

In another invention, in addition to the above-mentioned invention, a nozzle group making up the first nozzle row and a nozzle group making up the second nozzle row are arranged such that they are in a same position in a sub-scanning direction. Thus, ink not having color material can be discharged to positions suitable for its relationship with the ink having color material.

Further, a printing method employing a print head having a plurality of nozzles for ejecting ink to form dots, the print head having a first nozzle row for ejecting ink having color material and a second nozzle row for ejecting ink not having color material, comprises:
a step of discharging droplets of the ink having color material using the first nozzle row; and
a step of discharging droplets of the ink not having color material using the second nozzle row;
wherein a number per unit area of the droplets of the ink not having color material, which are discharged by the second nozzle row, is less than a number per unit area of the droplets of the ink having color material, which are discharged by the first nozzle row.

Thus, printing with the clear ink can be achieved using a simple configuration and without increasing the printing time.

Further, a print head having a plurality of nozzles for ejecting ink to form dots, comprises:
a first nozzle row for ejecting ink having color material; and
a second nozzle row for ejecting ink not having color material;
wherein a number of nozzles making up the second nozzle row is less than a number of nozzles making up the first nozzle row.

Thus, printing with the clear ink can be achieved using a simple configuration and without increasing the printing time.

Further, a printing method for performing printing on a medium, comprises:
a step of discharging droplets of ink having color material to a medium at a predetermined resolution; and
a step of discharging droplets of ink not having color material to the medium at a resolution that is different from the predetermined resolution.

Furthermore, in this printing method, the droplets of the ink not having color material may be discharged to the medium at a resolution that is lower than the predetermined resolution.

Further, a printing apparatus comprises
a print head for ejecting ink to form dots, wherein the print head includes:
a first nozzle row for discharging droplets of ink having color material to a medium at a predetermined resolution; and
a second nozzle row for discharging droplets of ink not having color material to the medium at a resolution that is different from the predetermined resolution.

Furthermore, in this printing apparatus, the second nozzle row may discharge the droplets of the ink not having color material to the medium at a resolution that is lower than the predetermined resolution.

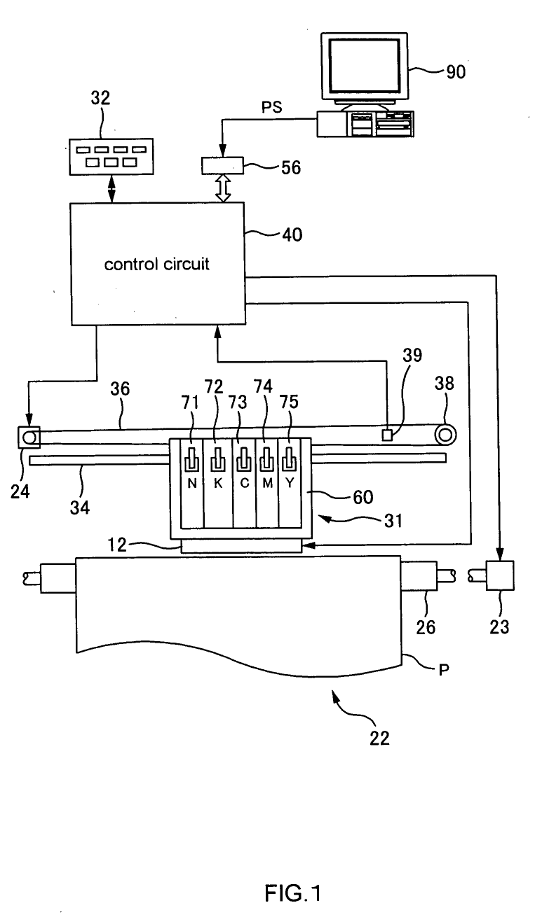

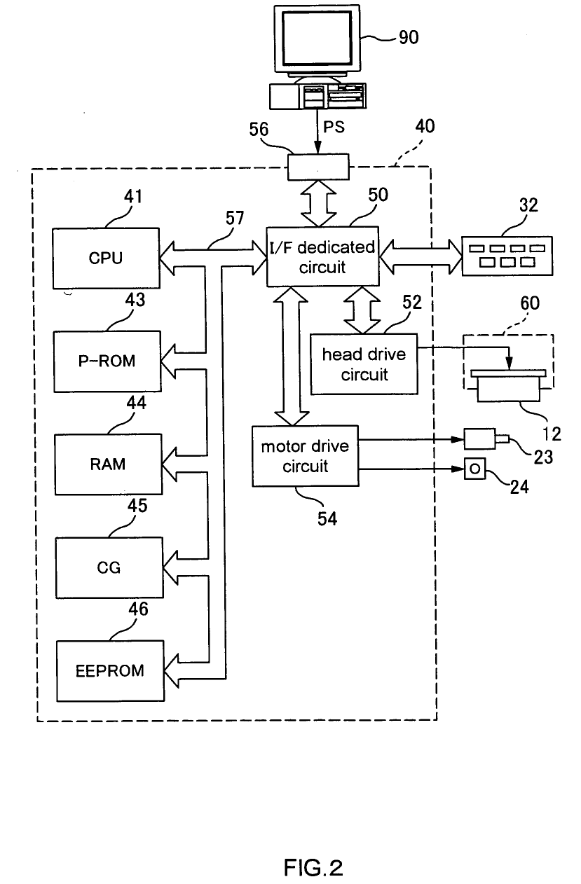

First, an overview of a printing apparatus and a computer system for printing is provided with reference to FIG. 1 and FIG. 2. FIG. 1 is a structural diagram that schematically shows a computer system for printing provided with an inkjet printer (hereinafter, abbreviated to “printer”) 22, which is a printing apparatus. FIG. 2 is a block diagram showing an example of a structure of the primary components of the printer 22, focusing on a control circuit 40.

As shown in FIG. 1, the printer 22 has a sub-scan feed mechanism for carrying a print paper P by a paper feed motor 23, and a main-scan feed mechanism for moving a carriage 31 back and forth in the axial direction of a paper feed roller 26 using a carriage motor 24. Here, the direction in which the print paper P is fed by the sub-scan feed mechanism is referred to as the sub-scanning direction, and the direction in which the carriage 31 is moved by the main-scan feed mechanism is referred to as the main-scanning direction.

Also, the printer 22 is provided with a print head unit 60, which is mounted to the carriage 31 and provided with a print head 12, a head drive mechanism for driving the print head unit 60 to control the ejection of ink and dot formation, and the control circuit 40 for sending and receiving signals to and from the paper feed motor 23, the carriage motor 24, the print head unit 60, and a control panel 32.

The control circuit 40 is connected to a computer 90 via a connector 56. The computer 90 is provided with a driver for the printer 22, and constitutes a user interface for receiving commands created by a user operating an input device such as a keyboard or a mouse, and for displaying various types of information about the printer 22 through a screen display of a display device.

The sub-scan feed mechanism for carrying the print paper P is provided with a gear train (not shown) that transmits the rotation of the paper feed motor 23 to the paper feed roller 26 and a paper carry roller (not shown).

Also, the main-scan feed mechanism for moving the carriage 31 back and forth is provided with a slide shaft 34 installed parallel to the shaft of the paper feed roller 26 and slidably retains the carriage 31, a pulley 38, wherein an endless drive belt 36 is provided spanning between the pulley 38 and the carriage motor 24, and a position detection sensor 39 for detecting the position of origin of the carriage 31.

As shown in FIG. 2, the control circuit 40 is constituted by an arithmetic and logic circuit that is provided with a CPU (Central Processing Unit) 41, a programmable ROM (P-ROM (Read Only Memory)) 43, a RAM (Random Access Memory) 44, a character generator (CG) 45 storing character dot matrix, and an EEPROM (Electronically Erasable and Programmable ROM) 46.

The control circuit 40 is further provided with an I/F dedicated circuit 50, which is an interface (I/F) with respect to external motors etc., a head drive circuit 52 connected to the I/F dedicated circuit 50 for driving the print head unit 60 and causing it to eject ink, and a motor drive circuit 54 for driving the paper feed motor 23 and the carriage motor 24.

The I/F dedicated circuit 50 is internally provided with a parallel interface circuit, and is capable of receiving print signals PS that are supplied from the computer 90 via the connector 56.

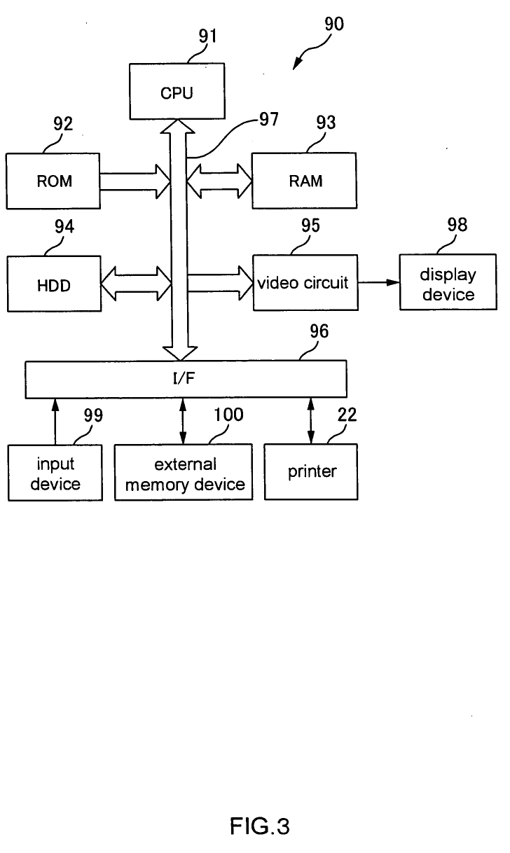

The configuration of the computer 90 is described next with reference to FIG. 3.

As shown in FIG. 3, the computer 90 is constituted by a CPU 91, a ROM 92, a RAM 93, an HDD (Hard Disk Drive) 94, a video circuit 95, an I/F 96, a bus 97, a display device 98, an input device 99, and an external memory device 100.

Here, the CPU 91 is a controller for executing various computing processes in accordance with programs stored in the ROM 92 or the HDD 94, and controls the various sections of the apparatus.

The ROM 92 is a memory storing basic programs executed by the CPU 91 and data. The RAM 93 is a memory for temporarily storing programs being executed by the CPU 91 and data being computed, for example.

The HDD 94 is a storage device for reading out data or programs stored on a hard disk, which is a storage medium, in accordance with requests from the CPU 91, and for recording data generated as the outcome of computer processing by the CPU 91 on the hard disk.

The video circuit 95 is a circuit for executing drawing processing in accordance with draw commands supplied from the CPU 91, and converting obtained image data into a video signal, then outputting this signal to the display device 98.

The I/F 96 is a circuit for suitably converting the expression format of signals that are output from the input device 99 and the external memory device 100, and outputting a print signal PS to the printer 22.

The bus 97 is a signal line that connects the CPU 91, the ROM 92, the RAM 93, the HDD 94, the video circuit 95, and the I/F 96 to one another, allowing data to be sent and received between them.

The display device 98 is configure with, for example, an LCD (Liquid Crystal Display) monitor or a CRT (Cathode Ray Tube) monitor, and is a device for displaying images corresponding to video signals output from the video circuit 95.

The input device 99 is configure with, for example, a keyboard and a mouse, and is a device for generating signals corresponding to operations performed by a user and supplying these signals to the I/F 96.

The external memory device 100 is configure with, for example, a CD-ROM (Compact Disk-ROM) drive unit, an MO (Magneto Optic) drive unit, or an FDD (Flexible Disk Drive) unit, and is a device for reading data and programs stored on CD-ROM disks, MO disks, or FDs and supplying these to the CPU 91. If the external memory device 100 is an MO drive unit or an FDD unit, then it also functions as a device for storing data supplied from the CPU 91 on an MO disk or an FD.

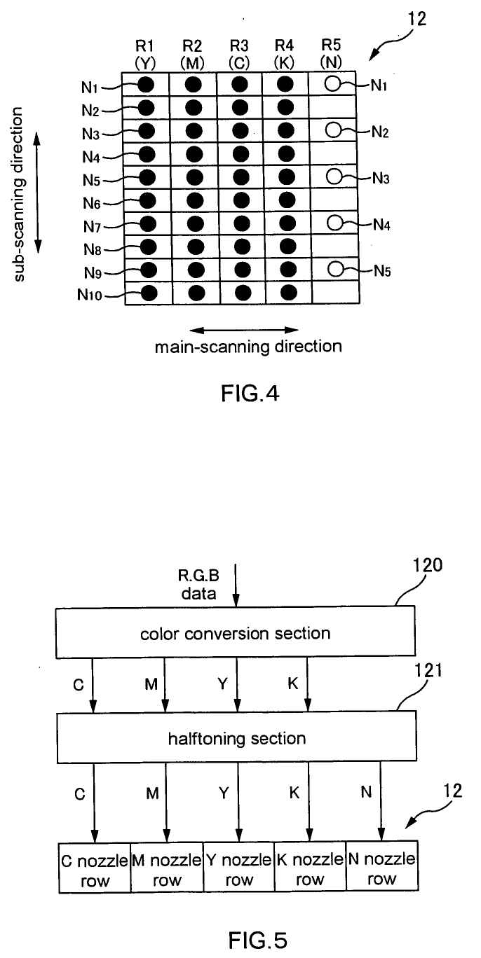

The configuration of the print head 12 is described next with reference to FIG. 1 and FIG. 4.

As shown in FIG. 1, five ink cartridges 71 to 75, namely a cartridge 71 containing clear (N) ink, a cartridge 72 containing black (K) ink, a cartridge 73 containing cyan (C) ink, a cartridge 74 containing magenta (M) ink, and a cartridge 75 containing yellow (Y) ink, are removably mounted to the carriage 31. It should be noted that the composition of the clear ink and the color inks differs according to the application thereof, and thus is described in detail later.

As shown in FIG. 1, the print head 12 is provided in a lower section of the carriage 31. As shown in FIG. 4, nozzles, which serve as ink ejection locations, are arranged in the print head 12 in rows in the direction in which the print paper P is carried, forming nozzle rows R1 to R5.

Piezoelectric elements, which are a type of electrostrictive element with excellent responsiveness, are arranged for each nozzle in the nozzle rows R1 to R5, which are provided in the lower section of the carriage 31 for each type of ink. The piezoelectric elements are arranged at positions in contact with members forming the ink paths over which ink is guided to the nozzles. When voltage is applied to the piezoelectric elements, their crystalline structure is deformed, and the elements convert the electrical energy to mechanical energy at an extremely high speed.

In this embodiment, voltage of a predetermined duration is applied between electrodes provided on both sides of each piezoelectric element, and this causes the piezoelectric element to expand during application of the voltage and thereby deform one lateral wall of the ink path. As a result, the volume of the ink path is constricted by an amount according to the expansion of the piezoelectric element, and ink corresponding to this amount of constriction is ejected at high speed from the tip of a nozzle as an ink droplet. The ink droplet soaks into the print paper P, which is guided along the paper feed roller 26, forming a dot to carry out printing.

FIG. 4 is a diagram showing an arrangement of the nozzles in the print head 12 (with the nozzles 12 viewed from the perspective of the print paper P). As shown in the figure, the print head 12 is constituted by the five nozzle rows R1 to R5 for ejecting yellow (Y), magenta (M), cyan (C), black (K), and clear (N) ink, respectively, arranged in the sub-scanning direction. Here, the nozzle rows R1 to R4 are for the color ink and serve as first nozzle rows, and are each made of ten nozzles N₁ to N₁₀. The nozzle row R5, which serves as the second nozzle row and is for the clear ink, is made of five nozzles N₁ to N₅, each nozzle arranged every other nozzle in the sub-scanning direction with respect to the nozzles N₁ to N₁₀ for the color ink. It should be noted that this is only one example of the number of nozzles and their arrangement, and there is no limitation of the present invention to this configuration. For example, it is also possible to provide a larger number of nozzles or to alter the arrangement in the main scanning direction of the nozzles of each color.

FIG. 5 is a diagram showing functional blocks of driver software for the printer 22 that is installed in the computer 90. As shown in the diagram, the driver software is constituted by a color conversion section 120 and a halftoning section 121, and the output of the halftoning section 121 is supplied to the nozzle rows.

The color conversion section 120 receives the input of image data such as RGB (Red, Green, Blue) full color image data, and color data that make up the input image data and that are expressed, for example, in the RGB color system is converted into color data in the CMYK color system having color components corresponding to the set of the color inks.

The halftoning section 121 executes processing such as error diffusion or dithering with respect to the image data output from the color conversion section 120 to convert data of multiple gradations (for example, 256 tones) of CMYK colors into, for example, binarized bitmap data expressed according to the density of the dots for each CMYK color.

The halftoning section 121, when creating bitmap data, creates N dot data indicating the dots of the clear ink in addition to the CMYK dot data indicating the dots of CMYK. For example, in the case of (1)—correcting unevenness in luster—discussed above, when considering a single or a plurality of pixels, the N dot data is set so that the clear ink is discharged in a supplementary manner such that the amount of discharged color ink in those dots or dot groups is within a predetermined range. It should be noted that the bitmap data output from the halftoning section 121 includes the C, M, Y, K, and N bitmap data mentioned above.

The bitmap data output from the halftoning section 121 is supplied to the print head 12, and droplets of C, M, Y, K, and N ink are ejected to form dots on the print paper P according to the bitmap data.

The operation of the present embodiment is described next. It should be noted that below, first the operation of the case corresponding to (1) “correcting unevenness in luster” is described, and then the operations of the cases corresponding to (2) “correcting ink bleeding” and (3) “improving the printing speed” are described. It should be noted that in the case of (1), ink obtained by dissolving a transparent polymer in water, which is a solvent, is employed as the clear ink, and inks obtained by dissolving pigment of each color in water, which is a solvent, are employed as the color inks.

When the input device 99 of the computer 90 is operated to request activation of the application program, the CPU 91 reads out that program from the HDD 94 and executes it. As a result, the application program is activated and it becomes possible to create and edit image data.

When a request to print a created image is made via the input device 99 after an image has been drawn or edited using this application program, the CPU 91 supplies the created image data to the driver software. It should be noted that the image data are data expressed in the RGB color system, and for example, the resolution in the height and width direction of the image data is 360 dpi (Dots Per Inch).

The color conversion section 120 of the driver software converts the image data that are received from the application program into image data expressed in the CMYK color system. It should be noted that it employs, for example, an LUT (Look Up Table) stored in the HDD 94 for this conversion process.

When conversion to the CMYK color system has finished, the color conversion section 120 executes error diffusion or dithering with respect to the image data (data of 256 tones) expressed in the CMYK color system obtained as a result of the conversion, and creates binarized bitmap data for each CMYK color. It should be noted that at this time, the resolution of the image is converted from the resolution of 360×360 dpi in height and width for when it was input to 720×720 dpi in height and width, which corresponds to the resolution of the print head 12.

The halftoning section 121 then creates bitmap data for the clear ink such that dots of the clear ink are formed at areas where the density of the dots of the color ink is low. That is, the halftoning section 121 creates bitmap data for the clear ink such that, when focusing on all of the inks CMYK and N, the amount of ink (mass or volume) that lands per unit area in each section of the print paper P is within a fixed range. It should be noted that the amount of the clear ink that is discharged is suitably set according to the degree of luster of the dots formed by the clear ink and the actual state of unevenness in luster when printing is performed.

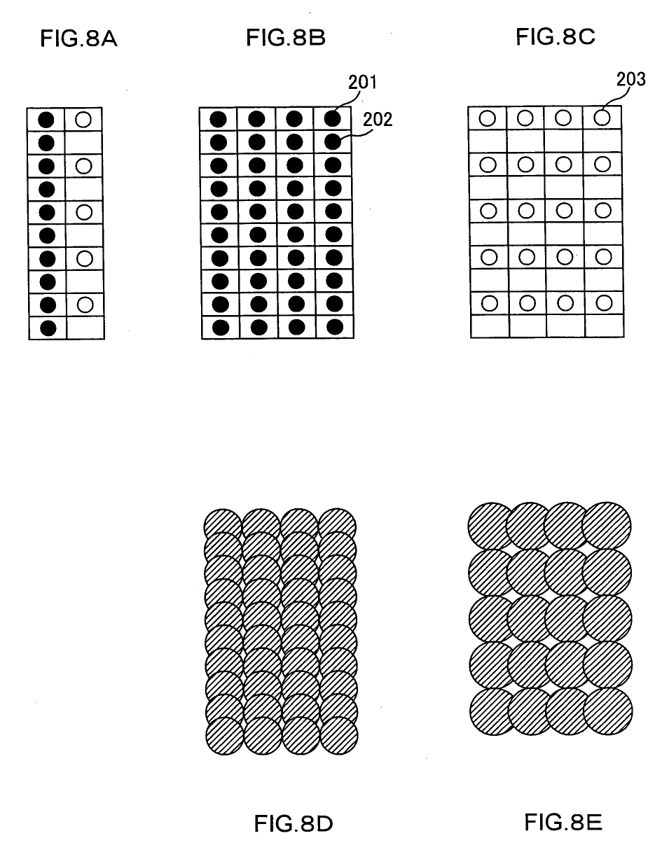

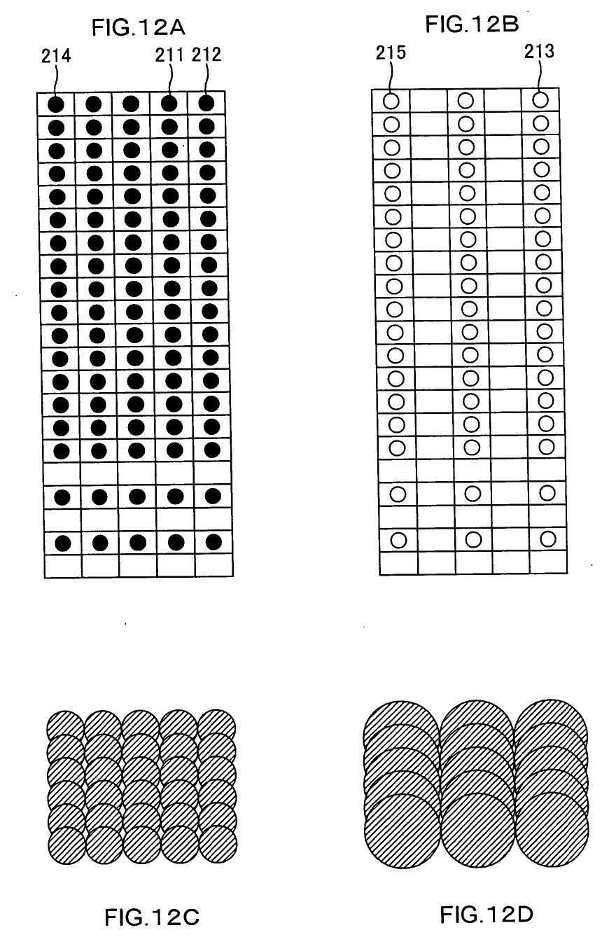

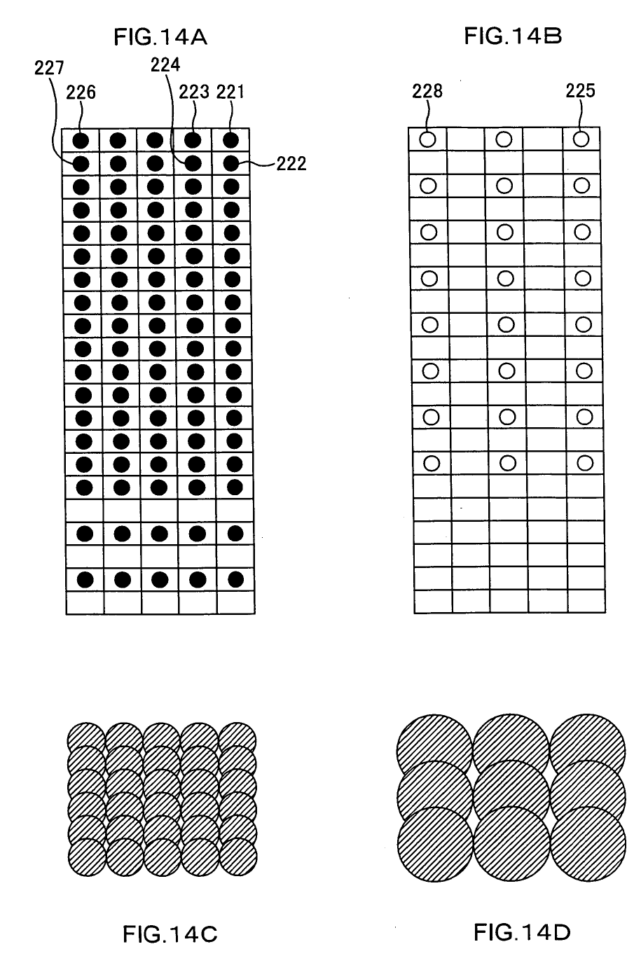

It should be noted that when, for example, the printing method shown in FIG. 8 is used (which is described later), the resolution of the height and width of the clear ink is 360 dpi and 720 dpi, respectively, and thus bitmap data adapted for this resolution is created. On the other hand, when the printing method shown in FIG. 12 is used (which is described later), the resolution of the height and width is 720 dpi and 360 dpi, respectively, and when the printing method shown in FIG. 14 is used (which is described later), both the resolutions of the height and width are 360 dpi, and thus bitmap data of a resolution corresponding to these are created.

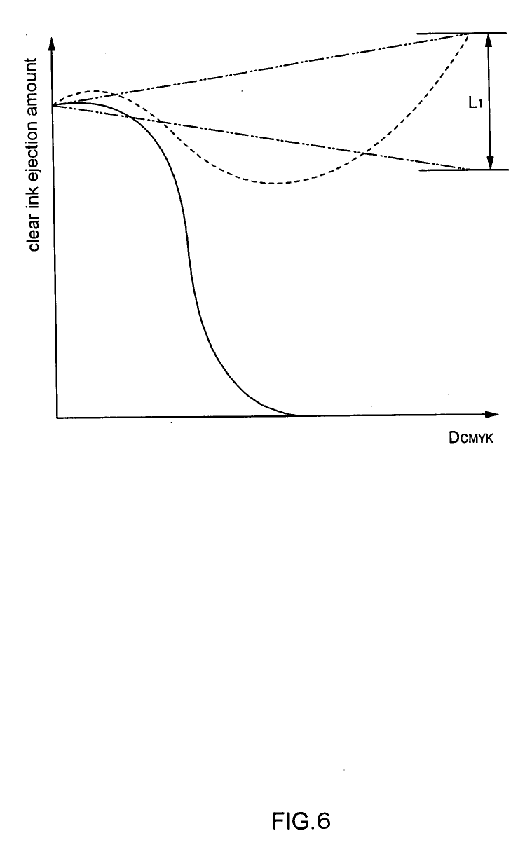

More specifically, for example, assuming that the total discharged amount of CMYK ink for a pixel (or group) is D_{CMYK} when focusing on that pixel or those plurality of pixels, the ejected amount of the clear ink is determined based on the solid curved line shown in FIG. 6 according to the discharged amount D_{CMYK}. That is, when D_{CMYK} is small, then the ejected amount of the clear ink (or the density of dots formed) is increased, and when D_{CMYK} is large, then the ejected amount of the clear ink (or the density of dots formed) is decreased. Also, if the number of pixels that are focused on increases or decreases when creating a single piece of bitmap data for the clear ink, then it is possible to change the resolution of the bitmap data for the clear ink. Further, if the resolution is to be increased (for example, when converting 360 dpi to 720 dpi), then the resolution can be raised through, for example, interpolation processing based on linear prediction.

It should be noted that the dotted curve line of FIG. 6 indicates the total discharged amount of clear ink and CMYK ink. As shown by this dotted curved line, the total discharged amount of clear ink and CMYK ink is set such that it is within a predetermined range L1. It should be noted that instead of an S-shaped curved line like the solid curved line, in which the amount of the clear ink is large but its decreasing degree is kept low within a range where D_{CMYK} is small and then the ejected amount of the clear ink quickly drops and finally edges slowly toward zero, it is also possible for the total discharged amount to be a constant value or to suddenly increase or decrease as shown by the long-short dashed lines of FIG. 6.

The bitmap data of the color ink and the clear ink created in this manner are output from the halftoning section 121 and supplied to the printer 22 via the I/F section 96. In the printer 22, the CPU 41 receives these data. The CPU 41 drives the paper feed motor 23 to draw out a single sheet of print paper P and sends it to the print start position. Then, when the print start position of the print paper P has moved to directly below the print head 12, the received bitmap data are supplied to the print head 12 via the head drive circuit 52 and printing begins. At this time, the bitmap data of the clear ink is supplied to the nozzle row R5 of the print head 12, and the other bitmap data are respectively supplied to the nozzle rows R1 to R4.

When printing begins, the CPU 41 repeatedly performs the operation of scanning the carriage 31 in the main scanning direction while ejecting the color ink from the nozzle rows R1 to R4 and the clear ink from the nozzle row R5 and intermittently carrying the print paper P in the sub-scanning direction. As a result, the dot group corresponding to the image data created by the computer 90 is formed on the print paper P.

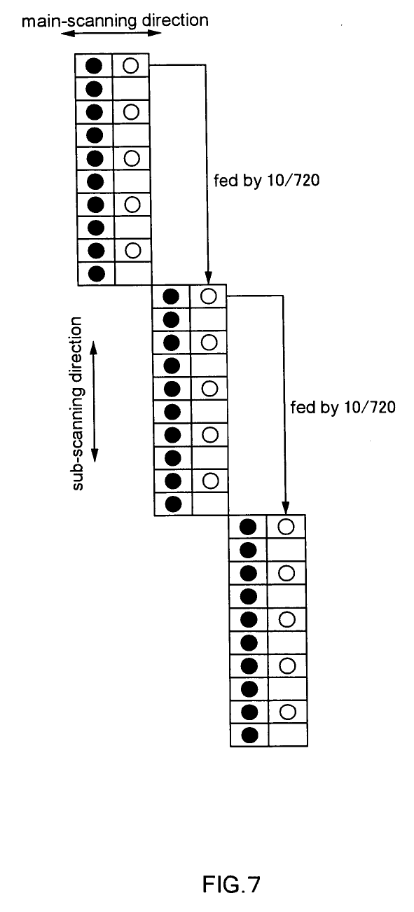

FIG. 7 is a diagram for describing the printing operation in detail. It should be noted that in this diagram only the nozzle row R4 and the nozzle row R5 are shown so as to simplify the figure. As shown in FIG. 7, the print head 12 is scanned in the main scanning direction to carry out printing by ejecting the color ink and the clear ink, and when scanning of a first line is complete, the print paper P is moved in the sub-scanning direction by 10/720 inch, that is, the distance corresponding to the width of the print head 12 in the sub-scanning direction, and scanning of the second line begins.

Then, when scanning of the second line is complete, the print paper P is similarly moved by 10/720 inch and scanning of the third line begins. This operation is repeated until the printing of all lines is complete.

FIG. 8 are diagrams showing an example of the dot pattern formed on the print paper P through the above operation. FIG. 8A shows how the nozzle rows R4 and R5 are arranged. Further, FIG. 8B and FIG. 8C are diagrams that show how ink is discharged by the nozzle rows R4 and R5. As shown in FIG. 8B, the color ink that is discharged from the nozzle row R4 is discharged to the print paper P at a density of 720 dpi in height and width, respectively. On the other hand, as shown in FIG. 8C, the clear ink that is discharged from the nozzle row R5 is discharged to the print paper P at a density of 720 dpi in the width direction and a density of 360 dpi in the height direction. It should be noted that the amount of ink droplets discharged at this time is set such that the amount of clear ink droplets is greater than that of the color ink. More specifically, for example, the dot diameter of the color ink is set to 40 μm and the dot diameter of the clear ink is set to 81 μm. As a result, small dots such as those shown in FIG. 8D are formed on the print paper P in the case of the color ink, where as large dots such as those shown in FIG. 8E are formed in the case of the color ink, filling up the paper surface without leaving gaps.

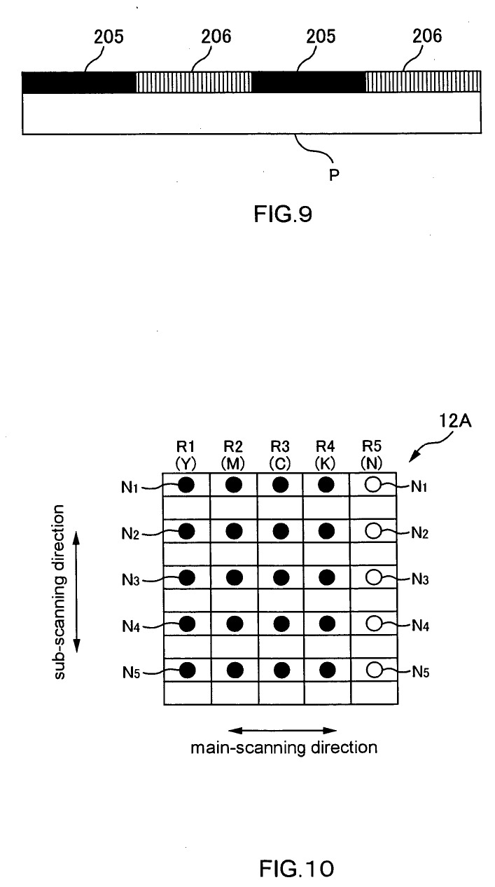

FIG. 9 is a schematic view of a cross section of the print paper P printed according to the present embodiment. As shown in FIG. 9, dots 205 of the color ink are formed on the surface of the print paper P, and dots 206 of the clear ink are formed in regions to which little or no pigment-based color ink adheres. Thus, the adhesion amount of ink to the surface of the print paper P becomes substantially uniform, reducing differences in the light reflectivity, that is, unevenness in luster. It should be noted that this figure is a schematic representation, and as shown in the figure, the clear ink is not necessarily discharged to every region to which the color ink has not been discharged.

As described above, in this embodiment, the clear ink is discharged in a supplementary manner to regions where little color ink has been discharged, and thus the degree of luster of these areas is raised and unevenness in luster can be prevented from occurring. Also, since the nozzle group constituting the nozzle row R5 for the clear ink has a half the number of nozzles as the nozzle rows R1 to R4 for the color ink, the configuration of the print head 12 can be simplified and manufacturing costs can be reduced. Further, by lowering the resolution of the bitmap data for the clear ink, it is possible to reduce the processing amount when creating bitmap data for the clear ink and the speed of the printing process can be increased. Also, the amount of data that is transferred from the computer 90 to the printer 22 can be reduced, and this also allows the speed of the printing process to be increased.

Also, by reducing the number of clear ink droplets that are discharged per unit area, the amount of clear ink consumption can be kept low compared to a case in which the same number of clear ink droplets as color ink droplets is discharged.

It should be noted that the clear ink generally has a higher degree of luster than an equal amount of the color ink, and thus unevenness in luster can be sufficiently corrected even if the number of nozzle groups constituting the nozzle row R5 is reduced. Also, even if the degree of luster of the clear ink is equal to or less than that of the other inks, the above can still be adopted by increasing the ejected amount of the clear ink. Furthermore, the quality of the image does not significantly change even if the number of clear ink nozzles is reduced, as compared to the case with color inks, and thus the merit of allowing the configuration of the print head 12 to be simplified is greater than the demerit of deterioration in image quality due to a reduction in the number of nozzles.

In the present embodiment, it should be noted that the position and the discharged amount of clear ink were determined such that the total discharged amount of clear ink and color ink per unit area in all regions of the image is within a predetermined range. However, as discussed above, unevenness in luster is particularly noticeable near the border between the areas where the color ink has been discharged and the areas where the color ink has not been discharged, and in view of this, it is also possible to discharge the clear ink in the middle between these areas. More specifically, it is also possible to find the D_{CYK} for the entire image data, spatially differentiate the obtained two-dimensional data, and discharge the clear ink to regions whose value is large but small in D_{CMYK} value (regions adjacent to areas where the color ink has been discharged). By doing this, it is possible to effectively prevent the occurrence of unevenness in luster and also to keep the amount of clear ink consumption to be low.

FIG. 10 is a diagram showing an example of another configuration of the print head 12. In the print head 12A shown in this figure, the five nozzles N₁ to N₅ in each of the nozzle rows R1 to R5 are arranged at a pitch of every other nozzle in the sub-scanning direction (at a density of 360 dpi).

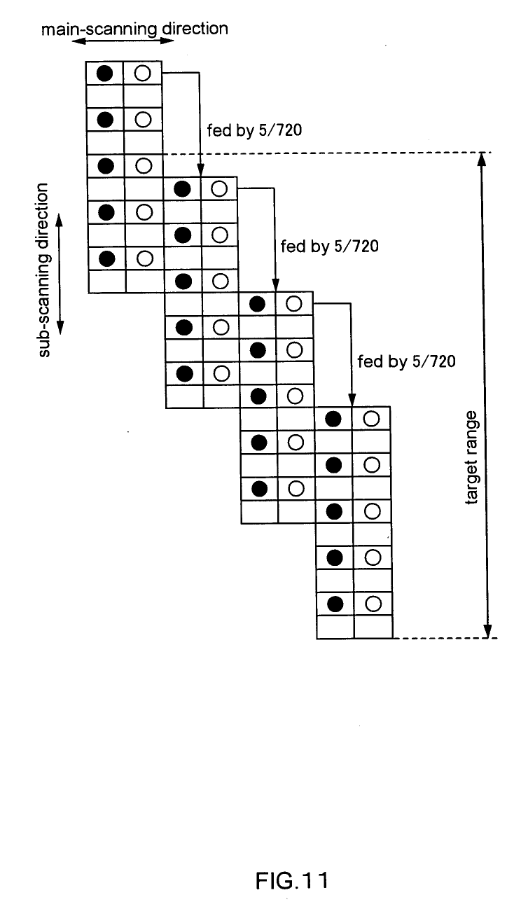

FIG. 11 is a diagram for describing the printing operation using the print head 12A shown in FIG. 10. In the example of this diagram, from the computer 90, bitmap data of 720 dpi×720 dpi in height and width, respectively, are supplied for the color ink, and bitmap data of 720 dpi×360 dpi in height and width, respectively, are supplied for the clear ink. It should be noted that in this diagram only the nozzle rows R4 and R5 are shown in order to simplify the diagram.

As shown in FIG. 11, in the printing operation employing the print head 12A, the first line is printed by a first scan. Color ink is discharged at this time such that in the width direction its density is 720 dpi, whereas clear ink is discharged at a frequency that is half the frequency of the color ink, such that its density is 360 dpi. Also, in the first line, ink is not ejected from the top two nozzles of each nozzle row.

Then, when scanning for the first line is complete, the print paper P is fed by 5/720 inch and scanning for the second line starts. It should be noted that at this time, like in the above case, the color ink is ejected at a density of 720 dpi and the clear ink is ejected at a density of 360 dpi in the width direction. Moreover, at this time, ink is ejected from all of the nozzle rows. When printing of the second line is complete, the print paper P is fed by 5/720 inch as previously described and scanning for the third line starts. This operation is then repeated, and when printing the final line, ink is not ejected from the bottom two nozzles. Printing of all of the lines is thus completed.

FIG. 12 are diagrams showing an example of the dot pattern that is formed on the print paper P. FIG. 12A and FIG. 12B are diagrams showing the condition how ink is discharged by the nozzle rows R4 and R5. As shown in FIG. 12A, the color ink that is discharged from the nozzle row R4 is discharged to the print paper P at a density of 720 dpi both in the height and width directions. On the other hand, as shown in FIG. 12B, the clear ink, which is discharged from the nozzle row R5, is discharged to the print paper P at a density of 720 dpi in the height direction and a density of 360 dpi in the width direction. It should be noted that the amount of ink of the droplets discharged at this time is set such that more clear ink is discharged than the color ink. More specifically, for example, the dot diameter of the color ink is set to 40 μm and the dot diameter of the clear ink is set to 81 μm. Thus, small dots such as those shown in FIG. 12C are formed on the print paper P in the case of the color ink, whereas large dots such as those shown in FIG. 12D are formed in the case of the clear ink, thereby filling up the paper surface without leaving gaps.

With the above embodiment, by lowering the density at which the dots of the clear ink are discharged in the width direction, it is possible to lower the resolution of the bitmap data for the clear ink, reduce overloading of the printing process, and increase the speed at which data are transferred from the computer 90 to the printer 22, thus allowing the printing speed to be increased.

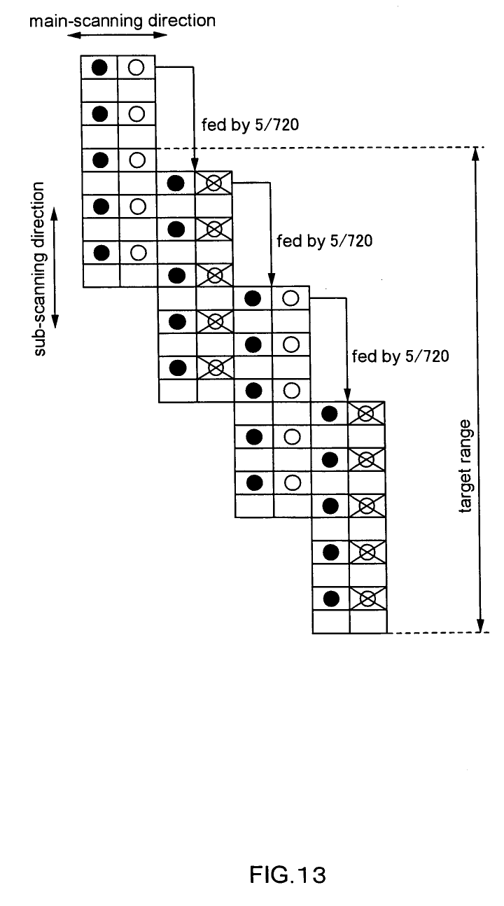

FIG. 13 is a diagram showing another example of a printing method using the print head 12A shown in FIG. 10. With the printing operation shown in this diagram, the first line is printed by the first scan. At this time, the color ink is discharged such that its density in the width direction is 720 dpi. On the other hand, the clear ink is discharged at a frequency that is half the frequency of the color ink, such that its density is 360 dpi in the width direction. Also, in the first line, ink is not ejected from the top two nozzles of each nozzle row.

When scanning for the first line is complete, the print paper P is fed by 5/720 inch and scanning for the second line starts. It should be noted that at this time the color ink is ejected at a density of 720 dpi in the width direction, but the ejection of the clear ink is stopped. Also, the color ink is ejected from all of the nozzle rows. When printing of the second line is complete, the print paper P is fed by 5/720 inch as previously described and scanning for the third line starts. When printing the third line, like when printing the first line, printing with the color ink is carried out at a density of 720 dpi and printing with the clear ink is carried out at a density of 360 dpi in the width direction. This operation is repeated, and when printing the final line, ink is not ejected from the bottom two nozzles. Thus, printing of all of the lines is completed.

FIG. 14 are diagrams showing an example of the dot pattern that is formed on the print paper P in the target range shown in FIG. 13. FIG. 14A and FIG. 14B are diagrams showing how ink discharged from the nozzle rows R4 and R5 is arranged. As shown in FIG. 14A, the color ink that is discharged from the nozzle row R4 is discharged to the print paper P at a density of 720 dpi both in the height and width directions. On the other hand, as shown in FIG. 14B, the clear ink that is discharged from the nozzle row R5 is discharged to the print paper P at a density of 360 dpi in both the height and width directions. It should be noted that the amount of ink in the droplets discharged at this time is set such that more clear ink is discharged than the color ink. More specifically, for example, the dot diameter of the color ink is set to 40 μm and the dot diameter of the clear ink is set to 102 μm. As a result, small dots such as those shown in FIG. 14C are formed on the print paper P in the case of the color ink, whereas large dots such as those shown in FIG. 14D are formed in the case of the color ink, filling up the paper surface.

With the above embodiment, by lowering the density at which dots of the clear ink are discharged in the width direction, it is possible to lower the resolution of the bitmap data for the clear ink, reduce overloading of the printing process, and increase the speed at which data are transferred from the computer 90 to the printer 22, thereby allowing the printing speed to be increased.

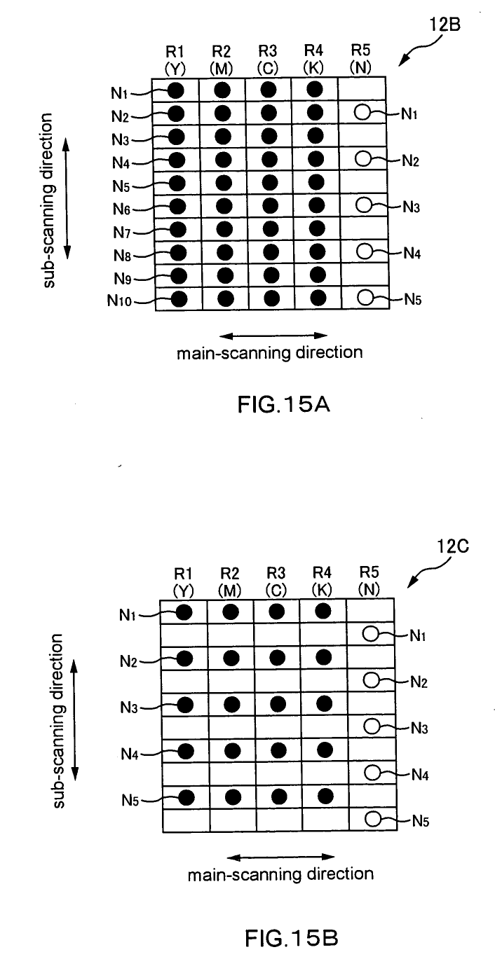

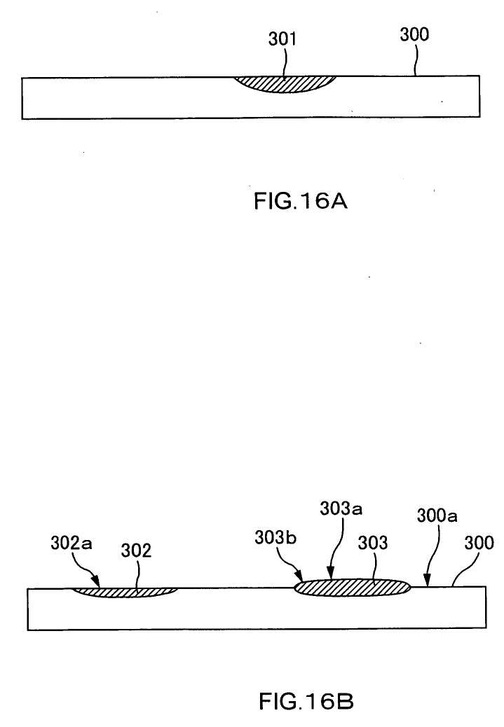

FIG. 15 are diagrams showing another example of the configuration of the print head 12. FIG. 15A shows a modified embodiment of the print head 12 shown in FIG. 4, and in this print head 12B, the nozzles making up the nozzle row R5 are shifted downward by one nozzle compared to the case of FIG. 4. This embodiment also allows the density at which the clear ink is discharged to be reduced using the same printing method as previously described in FIG. 4.

On the other hand, FIG. 15B shows a modified embodiment of the print head 12 shown in FIG. 10, and in this print head 12C, the nozzles making up the nozzle row R5 are shifted downward by one nozzle compared to the case of FIG. 10. With such an embodiment, the nozzles are shifted downward by one nozzle at the upper end of the target range shown in FIG. 11 or FIG. 13, and the nozzles are shifted upward by one nozzle at the lower end. Other than that, it is possible to reduce the density at which the clear ink is discharged using the same printing method as previously described in FIG. 11 or FIG. 13.

The operations corresponding to (2) “correcting ink bleeding” and (3) “improving the printing speed” are described next.

The composition of the color ink and the clear ink, and the operation of the halftoning section 121, are different in the cases corresponding to (2) “correcting ink bleeding” and (3) “improving the printing speed,” as compared to the case of (1) “correcting unevenness in luster” discussed above. Therefore, the following description focuses on the composition of the ink and the operation of the halftoning section 121.

First, in the case of (2) “correcting ink bleeding,” the pigment-based color ink is, for example, a water-based ink that includes a pigment-based color material and a cationic resin emulsion, and the clear ink is a reaction solution that includes an anionic resin emulsion and an anionic reactant that generates coagulation upon contact with the color ink composition.

Further, in the case of (1) “correcting unevenness in luster,” the clear ink was discharged to regions in which the color ink had not been discharged, but in the case corresponding to (2) “correcting ink bleeding,” it is necessary to discharge the clear ink to regions in which the color ink has been discharged.

Therefore, in the case corresponding to (2), when creating the bitmap data for the clear ink, the halftoning section 121 discharges the clear ink (sets the bitmap data to “1”), if either one of the pixels of the color ink that are adjacent to the clear ink pixel in the height direction (sub-scanning direction) is “1,” that is, if ink of anyone of the colors of CMYK is to be discharged. The clear ink is not discharged (the bitmap data is set to “0”) if both adjacent color ink pixels are “0,” that is, if no color of CMYK is to be discharged.

More specifically, using the dots on the uppermost right end in the diagrams of FIG. 8 as an example, when at least one of the dots 201 and 202 corresponding to the color ink is “1,” then the dot 203 corresponding to the clear ink is set to “1,” and when both dots are “0,” then the dot 203 corresponding to the clear ink is set to “0.”

Further, using the dots on the uppermost right end in the diagrams of FIG. 12 as an example, when at least one of the dots 211 and 212 corresponding to the color ink is “1,” then the dot 213 corresponding to the clear ink is set to “1,” and when both dots are “0,” then the dot 213 corresponding to the clear ink is set to “0.” It should be noted that for the dots positioned on the left end, when the dot 214 corresponding to the color ink is “1,” then the dot 215 corresponding to the clear ink is set to “1,” and when it is “0,” then the dot 215 corresponding to the clear ink is set to “0.”

Further, using the dots on the uppermost right end in the diagrams of FIG. 14 as an example, when at least one of the dots 221 to 224 corresponding to the color ink is “1,” then the dot 225 corresponding to the clear ink is set to “1,” and when all of these dots are “0,” then the dot 225 corresponding to the clear ink is set to “0.” It should be noted that for the dots positioned on the left end, if either the dot 226 or 227 corresponding to the color ink is “1,” then the dot 228 corresponding to the clear ink is set to “1,” and if both dots are “0,” then the dot 228 corresponding to the clear ink is set to “0.”

It should be noted that in the above examples, whether or not the clear ink is discharged is determined according to whether or not the color ink dots are to be formed, but it is also possible to vary the amount of ink droplets of the clear ink and to determine the amount of the clear ink that is discharged according to, for example, the amount of the color ink that is discharged. For example, in the example of FIG. 14, when at least one of the dots 221 to 224 is “1,” then an ink droplet of an amount corresponding to “1” is discharged, and when at least two dots are “1,” then an ink droplet of an amount corresponding to “2” is discharged.

The case corresponding to (3) is described next. In this case, the pigment-based color ink is, for example, a water-based ink that includes a pigment-based color material, and the clear ink is, for example, water which is a solvent.

In the case of (3), like in the case of (2) discussed above, it is necessary to discharge the clear ink to regions where the color ink has been discharged, and thus the bitmap data for the clear ink can be created using the same process as in the case previously described. It should be noted that in the case of (3) it is necessary that this processing is performed only for regions where solid printing is performed, and thus it is only necessary to specify the regions where solid printing is carried out and to create bitmap data of the clear ink for these regions using the process discussed above.

The bitmap data of the clear ink and the bitmap data of the color ink corresponding to (2) and (3) thus created are supplied to the printer 22 and printing is carried out on the print paper P in the same manner as previously described according to control by the CPU 41.

With the above embodiment, in the case of (2), the clear ink created by dissolving a substance, which prevents the bleeding of ink by causing the chemical change between the clear ink and the color ink, in a solvent is discharged near dots formed by the color ink, and accordingly, it becomes possible to prevent bleeding of the color ink.

Also, in the case of (3), it is, for example, possible to perform solid printing at high speed by introducing the clear ink made of only solvent near the dots formed by the color ink so as to induce bleeding of the color ink and increase the size of the dots to be greater than normal.

Moreover, in both (2) and (3), by reducing the number of clear ink droplets that is discharged per unit area, it is possible to reduce the bitmap data for the clear ink and shorten the time required for processing and the time required for transfer, thereby increasing the printing speed.

Also, by reducing the number of clear ink droplets that is discharged per unit area, it is possible to keep the amount of clear ink consumption low, when compared to that of the case in which the same number as color ink droplets is discharged.

Also, when the print head 12 shown in FIG. 4 is used, then it is possible to reduce the number of nozzles making up the nozzle row R5 for the clear ink in the print head 12, thus allowing the structure of the device to be simplified and manufacturing costs to be reduced.

Embodiments of the present invention are described above, but various modifications other than the above are possible with the present invention. For example, the four colors CMYK were used as the ink, but it is also possible to use light color inks (light cyan (LC), light magenta (LM), dark yellow (DY)) in addition to these colors.

Also, in the above embodiment, the ratio between the number of nozzles making up the nozzle row R5 for the clear ink and the number of nozzles making up each of the nozzle rows R1 to R4 for the color inks was 1/2, but ratios other than this (for example, n/m (where n<m)) are also possible.

Also, specific examples were provided for the composition of the ink, but the present invention is not limited to the specific examples provided.

Also, pigment-based inks are employed for the color inks in the above example, but (1) “correcting unevenness in luster” can also be applied to ink with a high degree of luster or dye-based ink. (2) “correcting ink bleeding” can also be applied to all inks for which the problem of bleeding occurs. Further, (3) “improving the printing speed” can be applied to all color inks for which diffusion of the ink is induced.

Also, as mentioned above, a printer 22 provided with a head that ejects ink using piezoelectric elements is employed, but it also possible to employ various ejection drive elements other than piezoelectric elements. For example, the present invention can also be applied to printers provided with ejection drive elements of a type that eject ink through the use of bubbles generated within the ink path by passing a current through a heater arranged in the ink path.

Furthermore, in the above embodiment, the processing of the color conversion section 120 and the halftoning section 121 is executed by driver software stored on the HDD 94 (or the external memory device 100). However, it is also possible to store a program having equivalent functions on the P-ROM 43 of the printer 22 and to execute the processing of the color conversion section 120 and the halftoning section 121 using this program, or to assign the processing tasks to the driver software and the printer 22.

1. A printing apparatus comprising:
a print head having a plurality of nozzles for ejecting ink to form dots, wherein said print head has a first nozzle row for ejecting ink having color material and a second nozzle row for ejecting ink not having color material;
wherein a number per unit area of droplets of said ink not having color material, which are discharged by said second nozzle row, is less than a number per unit area of droplets of said ink having color material, which are discharged by said first nozzle row.

2. A printing apparatus according to claim 1, wherein
a number of said droplets of said ink not having color material, which are discharged by said second nozzle row, per unit length in a main scanning direction is less than a number of said droplets of said ink having color material, which are discharged by said first nozzle row, per unit length in the main scanning direction.

3. A printing apparatus according to claim 1, wherein
a number of said droplets of said ink not having color material, which are discharged by said second nozzle row, per unit length in a sub-scanning direction is less than a number of said droplets of said ink having color material, which are discharged by said first nozzle row, per unit length in the sub-scanning direction.

4. A printing apparatus according to claim 1, wherein
a number of nozzles making up said second nozzle row is less than a number of nozzles making up said first nozzle row.

5. A printing apparatus according to claim 1, wherein
the nozzles making up said first and said second nozzle rows are arranged with a predetermined spacing between adjacent nozzles; and
scanning is carried out by partially overlapping scanning paths of said print head such that a gap created due to said spacing is filled in.

6. A printing apparatus according to claim 1, wherein:
said ink having color material is a pigment-based ink; and
said ink not having color material includes a component for increasing a degree of luster.

7. A printing apparatus according to claim 1, wherein
dots of said ink not having color material are formed at an area where a density of dots of said ink having color material is low in accordance with that density.

8. A printing apparatus according to claim 1, wherein:
said ink not having color material includes a component for preventing bleeding of said ink having color material; and
dots of said ink not having color material are formed at an area where a density of dots of said ink having color material is high in accordance with that density.

9. A printing apparatus according to claim 1, wherein
a nozzle group making up said first nozzle row and a nozzle group making up said second nozzle row are arranged such that they are misaligned in a sub-scanning direction by a fixed distance.

10. A printing apparatus according to claim 1, wherein
a nozzle group making up said first nozzle row and a nozzle group making up said second nozzle row are arranged such that they are in a same position in a sub-scanning direction.

11. A printing method employing a print head having a plurality of nozzles for ejecting ink to form dots, said print head having a first nozzle row for ejecting ink having color material and a second nozzle row for ejecting ink not having color material, said method comprising:
a step of discharging droplets of said ink having color material using said first nozzle row; and
a step of discharging droplets of said ink not having color material using said second nozzle row;
wherein a number per unit area of said droplets of said ink not having color material, which are discharged by said second nozzle row, is less than a number per unit area of said droplets of said ink having color material, which are discharged by said first nozzle row.

12. A print head having a plurality of nozzles for ejecting ink to form dots, comprising:
a first nozzle row for ejecting ink having color material; and
a second nozzle row for ejecting ink not having color material;
wherein a number of nozzles making up said second nozzle row is less than a number of nozzles making up said first nozzle row.

13. A printing method for performing printing on a medium, comprising:
a step of discharging droplets of ink having color material to a medium at a predetermined resolution; and
a step of discharging droplets of ink not having color material to the medium at a resolution that is different from said predetermined resolution.

14. A printing method according to claim 13, wherein
said droplets of said ink not having color material are discharged to the medium at a resolution that is lower than said predetermined resolution.

15. A printing apparatus comprising
a print head for ejecting ink to form dots, wherein said print head includes:
a first nozzle row for discharging droplets of ink having color material to a medium at a predetermined resolution; and
a second nozzle row for discharging droplets of ink not having color material to the medium at a resolution that is different from said predetermined resolution.

16. A printing apparatus according to claim 15, wherein
said second nozzle row discharges said droplets of said ink not having color material to the medium at a resolution that is lower than said predetermined resolution.
